(19) United States
(12) Patent Application Publication
(10) Pub. No.: US 2025/0256872 A1
(43) Pub. Date: Aug. 14, 2025

(54) APPARATUS FOR CAPACTITIVE LIQUID SENSING OF REFILLABLE ARTICLES FOR AEROSOL PROVISION SYSTEMS

(71) Applicant: NICOVENTURES TRADING LIMITED, London (GB)

(72) Inventor: Mohammed AL-AMIN, London (GB)

(21) Appl. No.: 18/857,964

(22) PCT Filed: Apr. 13, 2023
(86) PCT No.: PCT/GB2023/050991

§ 371 Date: Oct. 18, 2024

(30) Foreign Application Priority Data
Apr. 20, 2022 (GB) 2205747.5

(51) Int. Cl. B65B 3/30; A24F 40/10; B65B 39/04; G01F 22/00

(52) U.S. Cl. CPC B65B 3/30; A24F 40/10; B65B 39/04; G01F 22/00

(57) ABSTRACT

A refilling device for filling an article including an interface, for receiving an article of an aerosol provision system, the article having a storage area for fluid, or a reservoir interface for receiving a reservoir for filling the article, the reservoir having a storage area for fluid; and a capacitive sensor configured to measure a capacitance of the storage area when the article or reservoir is received in the interface; wherein the capacitive sensor includes a first capacitor plate and a second capacitor plate arranged at opposite sides of the interface to form a capacitance measurement volume in which the storage area of an article or reservoir is located when the article or reservoir is received in the interface, the capacitance measurement volume being between the first and second capacitor plates and extending from a perimeter of the first capacitor plate to a perimeter of the second capacitor plate, the capacitance measurement volume having a size such that the storage area of the article or reservoir received in the interface is located wholly within the capacitance measurement volume.

### RELATED APPLICATIONS

The present application is a National Phase entry of PCT Application No.: PCT/GB2023/050991 filed Apr. 13, 2023, which claims priority to GB Application No. 2205747.5 filed Apr. 20, 2022, of which is hereby incorporated by reference in their entirety.

### TECHNICAL FIELD

The present disclosure relates to apparatus for capacitive liquid sensing of refillable articles for electronic aerosol provision systems.

### BACKGROUND

Electronic aerosol provision systems, which are often configured as so-called electronic cigarettes, can have a unitary format with all elements of the system in a common housing, or a multi-component format in which elements are distributed between two or more housings which can be coupled together to form the system. A common example of the latter format is a two-component system comprising a device and an article. The device typically contains an electrical power source for the system, such as a battery, and control electronics for operating elements in order to generate aerosol. The article, also referred to by terms including cartridge, cartomizer, consumable and clearomizer, typically contains a storage volume or area for holding a supply of aerosolizable material from which the aerosol is generated, plus an aerosol generator such as a heater operable to vaporise the aerosolizable material. A similar three-component system may include a separate mouthpiece that attaches to the article. In many designs, the article is designed to be disposable, in that it is intended to be detached from the device and thrown away when the aerosolizable material has been consumed. The user obtains a new article which has been prefilled with aerosolizable material by a manufacturer and attaches it to the device for use. The device, in contrast, is intended to be used with multiple consecutive articles, with a capability to recharge the battery to allow prolonged operation.

While disposable articles, which may be called consumables, are convenient for the user, they may be considered wasteful of natural resources and hence detrimental to the environment. An alternative design of article is therefore known, which is configured to be refilled with aerosolizable material by the user. This reduces waste, and can reduce the cost of electronic cigarette usage for the user. The aerosolizable material may be provided in a bottle, for example, from which the user squeezes or drips a quantity of material into the article via a refilling orifice on the article. However, the act of refilling can be awkward and inconvenient, since the items are small and the volume of material involved is typically low. Alignment of the juncture between bottle and article can be difficult, with inaccuracies leading to spillage of the material. This is not only wasteful, but may also be dangerous. Aerosolizable material frequently contains liquid nicotine, which can be poisonous if it makes contact with the skin.

Therefore, refilling units or devices have been proposed, which are configured to receive a bottle or other reservoir of aerosolizable material plus a refillable cartridge, and to automate the transfer of the material from the former to the latter. Alternative, improved or enhanced features and designs for such refilling devices are therefore of interest.

### SUMMARY

According to a first aspect of some embodiments described herein, there is provided a refilling device for filling an article from a reservoir, comprising: an interface, the interface being an article interface for receiving an article of an aerosol provision system, the article having a storage area for fluid, or a reservoir interface for receiving a reservoir for filling an article of an aerosol provision system, the reservoir having a storage area for fluid; and a capacitive sensor configured to measure a capacitance of the storage area when the article or reservoir is received in the interface; wherein the capacitive sensor comprises a first capacitor plate and a second capacitor plate arranged at opposite sides of the interface to form a capacitance measurement volume in which the storage area of an article or reservoir is located when the article or reservoir is received in the interface, the capacitance measurement volume being between the first and second capacitor plates and extending from a perimeter of the first capacitor plate to a perimeter of the second capacitor plate, the capacitance measurement volume having a size such that the storage area of the article or reservoir received in the interface is located wholly within the capacitance measurement volume.

According to a second aspect of some embodiments described herein, there is provided a refilling system comprising: a refilling device according to the first aspect, wherein the interface is an article interface; and an article of an aerosol provision system, the article having a storage area for fluid which is located wholly within the capacitance measurement volume when the article is received in the article interface.

According to a third aspect of some embodiments described herein, there is provided a refilling system comprising; a refilling device according to the first aspect, wherein the interface is a reservoir interface; and a reservoir for filling an article of an aerosol provision system, the reservoir having a storage area for fluid which is located wholly with the capacitance measurement volume when the reservoir is received in the reservoir interface.

According to a fourth aspect of some embodiments described herein, there is provided a refilling device for filling an article from a reservoir, comprising: an interface, the interface being an article interface for receiving an article of an aerosol provision system, the article having a storage area for fluid, or a reservoir interface for receiving a reservoir for filling an article of an aerosol provision system, the reservoir having a storage area for fluid; and a capacitive sensor configured to measure a capacitance of the storage area when the article or reservoir is received in the interface; wherein the capacitive sensor comprises a first capacitor plate and a second capacitor plate arranged at opposite sides of the interface to form a capacitance measurement volume in which the storage area of an article or reservoir is located when the article or reservoir is received in the interface, the first capacitor plate having a first area and the second capacitor plate having a second area, the first area and the second area each being the range of 400 mm²-2000 mm².

These and further aspects of the certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, apparatus and methods for fluid sensing in refillable articles for electronic aerosol provision systems may be provided in accordance with approaches described herein which includes any one or more of the various features described below as appropriate.

### BRIEF DESCRIPTION OF THE DRAWINGS

Various embodiments of the invention will now be described in detail by way of example only with reference to the following drawings in which:

FIG. 1 shows a simplified schematic cross-section through an example electronic aerosol provision system in which embodiments of the present disclosure can be implemented;

FIG. 2 shows a simplified schematic representation of a refilling device to which embodiments of the present disclosure area applicable;

FIG. 3 shows a highly schematic and simplified side view representation of some of the components and parts of a first example refilling dock according to embodiments of the disclosure;

FIG. 4 shows a highly schematic and simplified side view representation of a first example article interface of a refilling dock with a capacitive sensor according to embodiments of the disclosure;

FIG. 5 shows a highly schematic and simplified end view of a second example article interface of a refilling dock with a capacitive sensor according to embodiments of the disclosure;

FIG. 6 shows a highly schematic and simplified cross-sectional plan view of a third example article interface of a refilling dock with a capacitive sensor according to embodiments of the disclosure;

FIG. 7 shows a highly schematic and simplified side view representation of a fourth example article interface of a refilling dock with a capacitive sensor according to embodiments of the disclosure;

FIG. 8 shows a highly schematic and simplified side view representation of a fifth example article interface of a refilling dock with a capacitive sensor according to embodiments of the disclosure;

FIG. 9 shows a highly schematic and simplified side view representation of a first example of a capacitor plate of a capacitive sensor for an article interface of a refilling dock according to embodiments of the disclosure; and

FIG. 10 shows a highly schematic and simplified side view representation of a second example of a capacitor plate of a capacitive sensor for an article interface of a refilling dock according to embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) electronic aerosol or vapor provision systems, such as e-cigarettes. Throughout the following description the terms “e-cigarette” and “electronic cigarette” may sometimes be used; however, it will be appreciated these terms may be used interchangeably with aerosol (vapor) provision system or device. The systems are intended to generate an inhalable aerosol by vaporisation of a substrate (aerosol-generating material) in the form of a liquid or gel which may or may not contain nicotine. Additionally, hybrid systems may comprise a liquid or gel substrate plus a solid substrate which is also heated. The solid substrate may be for example tobacco or other non-tobacco products, which may or may not contain nicotine. The terms “aerosol-generating material” and “aerosolizable material” as used herein are intended to refer to materials which can form an aerosol, either through the application of heat or some other means. The term “aerosol” may be used interchangeably with “vapor”.

As used herein, the terms “system” and “delivery system” are intended to encompass systems that deliver a substance to a user, and include non-combustible aerosol provision systems that release compounds from an aerosolizable material without combusting the aerosolizable material, such as electronic cigarettes, tobacco heating products, and hybrid systems to generate aerosol using a combination of aerosolizable materials, and articles comprising aerosolizable material and configured to be used within one of these non-combustible aerosol provision systems. According to the present disclosure, a “non-combustible” aerosol provision system is one where a constituent aerosol generating material of the aerosol provision system (or component thereof) is not combusted or burned in order to facilitate delivery to a user. In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery (END) system, although it is noted that the presence of nicotine in the aerosol generating material is not a requirement. In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and an article (consumable) for use with the non-combustible aerosol provision device. However, it is envisaged that articles which themselves comprise a means for powering an aerosol generator or aerosol generating component may themselves form the non-combustible aerosol provision system. In some embodiments, the non-combustible aerosol provision device may comprise a power source and a controller. The power source may, for example, be an electric power source. In some embodiments, the article for use with the non-combustible aerosol provision device may comprise an aerosol generating material, an aerosol generating component (aerosol generator), an aerosol generating area, a mouthpiece, and/or an area for receiving and holding aerosol generating material.

In some systems the aerosol generating component or aerosol generator comprises a heater capable of interacting with the aerosolizable material so as to release one or more volatiles from the aerosolizable material to form an aerosol. However, the disclosure is not limited in this regard, and applies also to systems that use other approaches to form aerosol, such as a vibrating mesh.

In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

As used herein, the term “component” may be used to refer to a part, section, unit, module, assembly or similar of an electronic cigarette or similar device that incorporates several smaller parts or elements, possibly within an exterior housing or wall. An aerosol provision system such as an electronic cigarette may be formed or built from one or more such components, such as an article and a device, and the components may be removably or separably connectable to one another, or may be permanently joined together during manufacture to define the whole system. The present disclosure is applicable to (but not limited to) systems comprising two components separably connectable to one another and configured, for example, as an article in the form of an aerosolizable material carrying component holding liquid or another aerosolizable material (alternatively referred to as a cartridge, cartomizer, pod or consumable), and a device having a battery or other power source for providing electrical power to operate an aerosol generating component or aerosol generator for creating vapor/aerosol from the aerosolizable material. A component may include more or fewer parts than those included in the examples.

The present disclosure relates to aerosol provision systems and components thereof that utilize aerosolizable material in the form of a liquid or a gel which is held in a storage area such as a reservoir, tank, container or other receptacle comprised in the system, or absorbed onto a carrier substrate. An arrangement for delivering the material from the reservoir for the purpose of providing it to an aerosol generator for vapor/aerosol generation is included. The terms “liquid”, “gel”, “fluid”, “source liquid”, “source gel”, “source fluid” and the like may be used interchangeably with terms such as “aerosol-generating material”, “aerosolizable substrate material” and “substrate material” to refer to material that has a form capable of being stored and delivered in accordance with examples of the present disclosure.

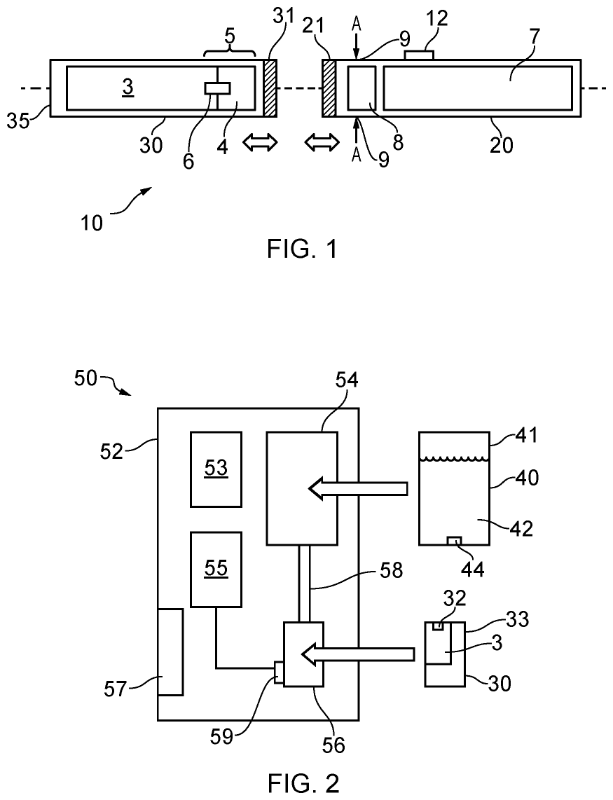

FIG. 1 is a highly schematic diagram (not to scale) of a generic example electronic aerosol/vapor provision system such as an e-cigarette 10, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomizer, clearomizer or pod) carrying aerosol-generating material and operating to generate vapor/aerosol.

The article 30 includes a storage area such as a reservoir 3 for containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavorings. Nicotine-free source liquid may also be used, such as to deliver flavoring. A solid substrate (not illustrated), such as a portion of tobacco or other flavor element through which vapor generated from the liquid is passed, may also be included. The reservoir 3 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that holds the aerosol generating material. For a consumable article, the reservoir 3 may be sealed after filling during manufacture so as to be disposable after the source liquid is consumed. However, the present disclosure is relevant to refillable articles that have an inlet port, orifice or other opening (not shown in FIG. 1) through which new source liquid can be added to enable reuse of the article 30. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 3 and is operable to generate the aerosol by vaporisation of the source liquid by heating. The aerosol-generating material transfer component 6 is a transfer or delivery arrangement configured to deliver aerosol-generating material from the reservoir 3 to the heater 4. In some examples, it may have the form of a wick or other porous element. A wick 6 may have one or more parts located inside the reservoir 3, or otherwise be in fluid communication with liquid in the reservoir 3, so as to be able to absorb source liquid and transfer it by wicking or capillary action to other parts of the wick 6 that are adjacent or in contact with the heater 4. This liquid is thereby heated and vaporised, and replacement liquid drawn, via continuous capillary action, from the reservoir 3 for transfer to the heater 4 by the wick 6. The wick may be thought of as a conduit between the reservoir 3 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 3 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 1. For example, and as mentioned above, the wick 6 may be an entirely separate element from the heater 4, or the heater 4 may be configured to be porous and able to perform at least part of the wicking function directly (a metallic mesh, for example). In the present example, the system is an electronic system, and the heater 4 may comprise one or more electrical heating elements that operate by ohmic/resistive (Joule) heating, although inductive heating may also be used, in which case the heater comprises a susceptor in an induction heating arrangement. A heater of this type could be configured in line with the examples and embodiments described in more detail below. In general, therefore, an atomiser or aerosol generator, in the present context, can be considered as one or more elements that implement the functionality of a vapor-generating element able to generate vapor by heating source liquid (or other aerosol-generating material) delivered to it, and a liquid transport or delivery element able to deliver or transport liquid from a reservoir or similar liquid store to the vapor-generating element by a wicking action/capillary force or otherwise. An aerosol generator is typically housed in an article 30 of an aerosol generating system, as in FIG. 1, but in some examples, at least the heater part may be housed in the device 20. Embodiments of the disclosure are applicable to all and any such configurations which are consistent with the examples and description herein.

Returning to FIG. 1, the article 30 also includes a mouthpiece or mouthpiece portion 35 having an opening or air outlet through which a user may inhale the aerosol generated by the heater 4.

The device 20 includes a power source such as cell or battery 7 (referred to hereinafter as a battery, and which may or may not be re-chargeable) to provide electrical power for electrical components of the e-cigarette 10, in particular to operate the heater 4. Additionally, there is a controller 8 such as a printed circuit board and/or other electronics or circuitry for generally controlling the e-cigarette. The controller may include a processor programmed with software, which may be modifiable by a user of the system. The control electronics/circuitry 8 operates the heater 4 using power from the battery 7 when vapor is required. At this time, the user inhales on the system 10 via the mouthpiece 35, and air A enters through one or more air inlets 9 in the wall of the device 20 (air inlets may alternatively or additionally be located in the article 30). When the heater 4 is operated, it vaporises source liquid delivered from the reservoir 3 by the aerosol-generating material transfer component 6 to generate the aerosol by entrainment of the vapor into the air flowing through the system, and this is then inhaled by the user through the opening in the mouthpiece 35. The aerosol is carried from the aerosol generator 5 to the mouthpiece 35 along one or more air channels (not shown) that connect the air inlets 9 to the aerosol generator 5 to the air outlet when a user inhales on the mouthpiece 35.

More generally, the controller 8 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 8 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as an screen or indicator) and user input detections via one or more user actuable controls 12. It will be appreciated that the functionality of the controller 8 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 1. The components 20, 30 are joined together when the system 10 is in use by cooperating engagement elements 21, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the article 30. An inductive work coil can be housed in the device 20 and supplied with power from the battery 5, and the article 30 and the device 20 shaped so that when they are connected, there is an appropriate exposure of the heater 4 to flux generated by the coil for the purpose of generating current flow in the material of the heater. The FIG. 1 design is merely an example arrangement, and the various parts and features may be differently distributed between the device 20 and the article 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware, but are most generally concerned with configurations comprising an article with a refillable storage area.

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system, having a storage area which is empty or only partly full, plus a larger reservoir holding aerosol generating material. A fluid communication flow path is established between the reservoir and the storage area, and a controller in the refilling device controls a transfer mechanism or arrangement operable to move aerosol generating material along the flow path from the reservoir to the storage area. The transfer mechanism can be activated in response to user input of a refill request to the refilling device, or activation may be automatic in response to a particular state or condition of the refilling device detected by the controller. For example, if both an article and a reservoir are correctly positioned inside the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as a fixed quantity matching the capacity of the storage area.

FIG. 2 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 50 may be referred to hereinafter for convenience as a “dock”. This term is applicable since a reservoir and an article are received or “docked” in the refilling device during use. The dock 50 comprises an outer housing 52. The dock 50 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 50 are defined two cavities or ports 54, 56. A first port 54 is shaped and dimensioned to receive and interface with a reservoir 40. The first or reservoir port 54 is configured to enable an interface between the reservoir 40 and the dock 50, so might alternatively be termed a reservoir interface. Primarily, the reservoir interface is for moving aerosol generating material out of the reservoir 40, but in some cases the interface may enable additional functions, such as electrical contacts and sensing capabilities for communication between the reservoir 40 and the dock 50 and determining characteristics and features of the reservoir 40.

The reservoir 40 comprises a wall or housing 41 that defines a storage space or storage area for holding aerosol generating material 42. The volume of the storage space is large enough to accommodate many or several times the storage area of an article intended to be refilled in the dock 50. A user can therefore purchase a filled reservoir of their preferred aerosol generating material (flavor, strength, brand, etc.), and use it to refill an article multiple times. A user could acquire several reservoirs 40 of different aerosol generating materials, so as to have a convenient choice available when refilling an article. The reservoir 40 includes an outlet orifice or opening 44 by which the aerosol generating material 42 can pass out of the reservoir 40. In the current context, the aerosol generating material 42 has a liquid form or a gel form, so may be considered as aerosol generating fluid. The term “fluid” may be used herein for convenience to refer to either a liquid or a gel material; where the term “liquid” is used herein, it should be similarly understood as referring to a liquid or a gel material, unless the context makes it clear that only liquid is intended.

A second port 56 defined inside the housing is shaped and dimensioned to receive and interface with an article 30. The second or article port 54 is configured to enable an interface between the article 30 and the dock 50, so might alternatively be termed an article interface. The article interface 56 is for receiving aerosol generating material into the article 30, and according to present example, the article interface enables additional functions, such as electrical contacts and sensing capabilities for communication between the article 30 and the dock 50 and determining characteristics and features of the article 30. In particular, the article interface 56 has associated with it one or more capacitive sensors 59 which may be interrogated by a controller 55 in the refilling dock 50 in order to obtain capacitance measurements related to the article 30 when received in the article interface 56 from which characteristics of the article can be ascertained.

The article 30 itself comprises a wall or housing 33 that has within it (but possibly not occupying all the space within the wall 31) a storage area 3 for holding aerosol generating material. The volume of the storage area 3 is many or several times smaller than the volume of the reservoir 40, so that the article 30 can be refilled multiple times from a single reservoir 40. The article also includes an inlet orifice or opening 32 by which aerosol generating material can enter the storage area 3. Various other elements may be included in the article, as discussed above with regard to FIG. 1. For convenience, the article 30 may be referred to as a pod 30.

The housing 52 of the dock also accommodates a fluid conduit 58, being a passage or flow path by which the reservoir 40 and the storage area 3 of the article 30 are placed in fluid communication, so that aerosol generating material can move from the reservoir 40 to the article 30 when both the reservoir 40 and the article 30 are correctly positioned in the dock 50. Placement of the reservoir 40 and the article 30 into the dock 50 locates and engages them such that the fluid conduit 58 is connected between the outlet orifice 44 of the reservoir 40 and the inlet orifice 32 of the article 30. Note that in some examples, all or part of the fluid conduit 58 may be formed by parts of the reservoir 40 and the article 30, so that the fluid conduit is created and defined only when the reservoir 40 and/or the article 30 are placed in the dock 30. In other cases, the fluid conduit 58 may be a flow path defined within a body of the dock 52, to each end of which the respective orifices are engaged.

Access to the reservoir port 54 and the article port 56 can be by any convenient means. Apertures may be provided in the housing 52 of the dock 50, through which the reservoir 40 and the article 30 can be placed or pushed. Doors or the like may be included to cover the apertures, which might be required to be placed in a closed state to allow refilling to take place. Doors, hatches and other hinged coverings, or sliding access elements such as drawers or trays might include shaped tracks, slots or recesses to receive and hold the reservoir 40 or the article 30, which bring the reservoir 40 or the article 30 into proper alignment inside the housing when the door etc. is closed. These and other alternatives will be apparent to the skilled person, and do not affect the scope of the present disclosure.

The dock 50 also includes an aerosol generating material (“liquid” or “fluid”) transfer mechanism, arrangement, apparatus or means 53, operable to move or cause the movement of fluid out of the reservoir 40, along the conduit 58 and into the article 30. Various options are contemplated for the transfer mechanism 53.

As already noted, a controller 55 is also included in the dock 50. This is operable to control components of the dock 50, in particular to generate and send control signals to operate the transfer mechanism. As noted, this may be in response to a user input, such as actuation of a button or switch (not shown) on the housing 52, or automatically in response to both the reservoir 40 and the article 30 being detected as present inside their respective ports 54, 56. The controller 55 may therefore be communication with contacts and/or sensors (such as the sensors 59 but otherwise not shown) at the ports 54, 56 in order to obtain data from the ports and/or the reservoir 40 and article 30 that can be used in the generation of control signals for operating the transfer mechanism 53. The controller 55 may comprise a microcontroller, a microprocessor, or any configuration of circuitry, hardware, firmware or software as preferred; various options will be apparent to the skilled person.

Finally, the dock 50 includes a power source 57 to provide electrical power for the controller 53, and any other electrical components that may be included in the dock, such as sensors, user inputs such as switches, buttons or touch panels, and display elements such as light emitting diodes and display screens to convey information about the dock's operation and status to the user. Also, the transfer mechanism may be electrically powered. Since the dock may be for permanent location in a house or office, the power source 57 may comprise a socket for connection of an electrical mains cable to the dock 50, so that the dock 50 may be “plugged in”. Alternatively, the power source may comprise one or more batteries, which might be replaceable or rechargeable, in which case a socket connection for a charging cable can be included.

Further details relating to the control of the refilling will now be described.

As noted above, the refilling process is governed by the controller of the refilling device, and includes the generation and sending of control signals to the transfer mechanism to cause it to start/stop the movement of fluid from the reservoir into the article. This can be performed so as to dispense a fixed amount of fluid that corresponds to the known capacity of the article's storage area, after which operation of the transfer mechanism ceases. More usefully, cessation of the fluid dispensing can be implemented in response to detection of a fluid level or amount in the article. The controller is configured to recognise when the storage area has become full, or otherwise filled to a required level, and to cause the transfer mechanism to stop transferring fluid in response. This allows an article to be refilled safely without spilling or pressure build-up in the storage area, regardless of an amount of fluid present in the article at the start of the refilling process. Articles can hence be topped up as well as completely or partially refilled from empty.

In the present disclosure, it is proposed to use a capacitive sensor to obtain capacitance measurements from which characteristics and properties of an article received in a refilling device can be determined. Characteristics may include a level of fluid in a storage area of the article, and the presence or absence of the article in the refilling device. The amount or type of a material between or in close proximity to a pair of capacitor plates determines the capacitance between the plates, so measurement of the capacitance can reveal properties of an item proximate to a capacitive sensor. In the current case, the item is the article, and the capacitance will be different when the article is present in the refilling device and proximate the capacitive sensor from the capacitance when the article is not present in the refilling device. Hence, the presence or absence of the article can be determined. Similarly, the volume of fluid in the storage device of the article affects the amount of material proximate the capacitive sensor when the article is in the refilling device, so the fluid amount or level can be determined from capacitance measurements. The same approach is also proposed for determining characteristics and properties of a reservoir received in a refilling device.

It is proposed that capacitance measurements relating to an article be obtained using a capacitive sensor incorporated in the article interface of the refilling device, or otherwise associated with the article interface so as to be positioned to interact with an article in the article interface (as shown in FIG. 2). The capacitive sensor comprises a pair of capacitor plates between which the article is located when in the article interface. An arrangement in which the capacitive sensor is part of the refilling dock, as opposed to being part of the article, reduces the complexity and cost of articles, and does not require any electrical connection to be made between the article and the refilling dock. For capacitance measurements relating to a reservoir, the capacitive sensor is incorporated in the reservoir interface of the refilling device, or otherwise associated with the reservoir interface.

The closed nature of the storage area (as opposed to an open vessel) and its small volume (particularly for the storage area of an article), coupled with potential viscosity of the fluid, can cause pockets or bubbles of air to form within the storage area when it is only partially full. An air pocket is mobile, and can displace the fluid into one or other region of the storage area in an unpredictable manner, and fluid movement during filling or emptying of the storage area (for an article or a reservoir respectively) can cause movement of an air pocket around the volume of the storage area. The size, location and motion of an air pocket during filling can depend on factors such as the speed of filling or emptying and the amount of fluid present in the storage area prior to filling. The result can be an apparently uneven and inconsistent fluid level during filling or emptying. If capacitance measurements are obtained using a capacitive sensor with relatively small plates, for example a vertical strip-shaped plate that extends along a filling/emptying direction depth of the storage area and that might therefore be expected to accurately capture an evolving fluid level during filling or emptying, an air pocket may move in and out of the capacitive sensing region between the plates as fluid is added, and distort the capacitance measurement so that the measurement does not correctly indicate the fluid level or volume. Similarly, if a partially filled article is placed in the dock to be fully filled, air pockets can cause a non-indicative amount of the fluid to be present in the sensing region, either too much or too little, so that an initial fluid level cannot be properly detected. A subsequent filling action may then not be accurately controlled, and result in over-filling or under-filling.

To address these issues, it is proposed to utilize a capacitive sensor which has what might be considered to be “over-sized” capacitance plates, in other words capacitance plates which cover at least the whole of the storage area, rather than only a portion of it. The total volume of the storage area is thereby captured by the capacitance measurement, including all the fluid present. Any movement of air pockets that may also be present can only change the position of the fluid within the capacitive sensing region, and not the amount of fluid. In this way, the capacitance measurement accurately corresponds to the total amount or depth of fluid in the storage area at all times (before, during and after a filling action), and the fluid amount can be correctly determined, providing better control of the filling action by the controller of the refilling dock.

The following examples and embodiments are described with reference to an article and an article interface of a refilling dock. It should be understood that the various details and features are equally applicable for a reservoir and where the interface is a reservoir interface of a refilling dock.

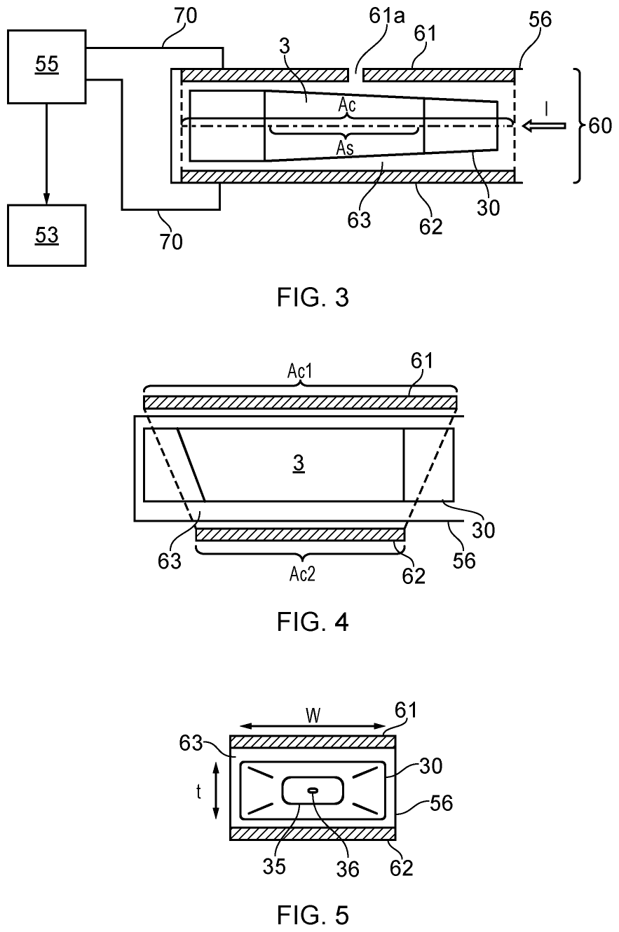

FIG. 3 shows a highly schematic and simplified side view representation of some of the components and parts of an example refilling dock such as that shown in FIG. 2, and for which like reference numerals are used where appropriate. Only those parts of the dock which are most relevant to the capacitive sensing are shown, for the sake of simplicity. Hence, the filling parts by which fluid is moved into the article are omitted. An article interface 56 is provided, being a cavity or space into which an article 30 is inserted or received. In this example, the article 30 has an elongate shape, and is inserted lengthwise and horizontally into the article interface 56 of the dock via an opening at one side of the article interface 56, as indicated by the arrow I. The article 30 has a storage area 3 for fluid, refillable by the refilling dock. This is shown schematically only in FIG. 3, and other internal components or elements of the article 30 are omitted for clarity. However, the storage area 3 typically occupies less than the full internal volume of the article 30, as shown, although it may be located within the article 30 in a different location than that shown. In this example, the article 30 is shown as having an elongate shape with one end of constant width, which may be an end which is coupled to a device to form an aerosol provision system, and a tapered end which may terminate in a narrower mouthpiece. The disclosure is not limited with regards to the physical shape, size and configuration of the article, however; the article may be otherwise shaped and have a differently located storage area than that shown in FIG. 3.

The article interface 56 has associated with it a capacitive sensor 60. This comprises a pair of capacitor plates which are mounted, in this example, on the interior surface of walls of a housing defining the cavity of the article interface 56. The capacitor plates are thin conductive elements, in the usual manner of a capacitor, and while shown as being flat or planar, may be curved or shaped to mirror the outer shaping of the article 30, and have an area which lies perpendicular to the plane of the page. A first capacitor plate 61 is mounted on a upper surface of the article interface 56, so that it lies above the article 30 in the depicted orientation, with its area roughly parallel to and extending across an upper surface of the received article 30. A second capacitor plate 62 is mounted on a lower surface of the article interface 56, so that it lies below the article in the depicted orientation, again with its area roughly parallel to and extending across a lower surface of the received article 30. Note that the capacitor plates 61, 62 are located inside the article interface 56 (in that the walls of the article interface 56 are not interposed between the article 30 and the capacitor plates 61, 62. A similar configuration can be achieved by forming the relevant walls of the article interface 56 directly from the capacitor plates 61, 62). Each capacitor plate 61, 62 has an electrical connection 70 to the controller 55 of the dock, by which the controller 55 can obtain capacitance measurements by driving the capacitor plates and detecting the capacitance of the capacitive sensor 60 in the known way. The controller 55 is additionally configured to deduce or determine an amount of fluid in the storage area 3 of the article 30 from one or more of these capacitance measurements, and control a filling action based on the determined amount of fluid, by operating the fluid transfer mechanism 53 of the dock to move fluid from the reservoir (not shown) into the storage area 3. The first capacitor plate 61 and the upper wall of the article interface 56 have one or more apertures or openings 61a through which an end of the fluid transfer mechanism (such as one or more nozzles for delivering fluid and venting air during the filling action) engages with the storage area 3. This is not a limiting arrangement however, and in other configurations the capacitor plate need not be located between the received article and the fluid transfer mechanism.

The first and second capacitor plates 61, 62 each have a perimeter extending around the edges of the conductive elements, and a space can be defined extending from the perimeter of the first capacitor plate 61 to the perimeter of the second capacitor plate 62. This space constitutes a capacitance measurement volume 63, the edges of which are shown by the dotted lines in FIG. 3, such that items placed within the capacitance measurement volume affect the capacitance measurable from the capacitive sensor 60. The first and second capacitor plates 61, 62 are sized and shaped such that when the article 30 is received in the article interface 56, the storage area 3 is located completely inside, and is wholly encompassed within, the capacitance measurement volume 63. The capacitance measurement volume 63 is at least the same size as, and generally larger than, the volume of the storage area 3, and the two volumes are arranged to be coincident when the article 30 is received in the article interface 56. A way of defining this spatial relationship is to consider a plane through the capacitance measurement volume which lies halfway or midway between the first capacitor plate 61 and the second capacitor plate 62, indicated by the dash-dot line in FIG. 3. The capacitance measurement volume 63 has a cross-sectional area Ac in this plane (one dimension of which is indicated in FIG. 3), while the storage area 3 of the received article 30 has a cross-sectional area As (one dimension of which is indicated in FIG. 3) which is equal to or smaller than the area Ac of the capacitance measurement volume. Note that in the FIG. 3 example, the first and second capacitor plates 61, 62 are parallel to one another, but this is not essential, and instead they may be inclined at an angle to one another, or otherwise non-parallel according to any shaping they may have, as may be convenient according to the shape of the article interface (which may be in part dictated by the outer shape of the article). Also, in the FIG. 3 example the first and second capacitor plates 61, 62 have substantially the same size and shape, with correspondingly equal areas. The perimeters of the plates 61, 62 are aligned so that the capacitance measurement volume 63 has side boundaries which are orthogonal to the planes of the plates 61, 62 and the midway plane. Hence the area of each capacitor plate 61, 62 is the same as the area Ac of the midway plane of the capacitance measurement volume. Note also that the plates 61, 62 are sized such that the capacitance measurement volume 63 is significantly larger than the storage area 3 so that it is large enough to accommodate the entirety of the article 30. Hence, the storage area 3 and the article 30 are both located wholly within the capacitance measurement volume. Various features of FIG. 3 regarding the size, shape and location of the capacitor plates are not essential, and other configurations are contemplated.

FIG. 4 shows a highly schematic and simplified representation of an article interface according to a further example. Other components of the dock are omitted for simplicity. The article interface 56 again is configured as a cavity which receives an article 30 in a horizontal orientation through an opening at one side. The article 30 has straight sides in this example, lacking the tapered mouthpiece of FIG. 3. As before, a first capacitor plate 61 is positioned above the article 30 and a second capacitor plate 62 is positioned below the article 30. In this example, however, the configuration differs from the FIG. 3 example in that the capacitor plates 61, 62 are located outside or externally of the article interface 56, so that the boundary walls of the article interface 56 are interposed between the capacitor plates 61, 62 and the article 30. Depending on the type and amount of material forming the walls which is present, this arrangement may reduce the sensitivity of the capacitive sensor 60, but the contribution of the walls to the overall capacitance measurement is fixed and can therefore be adjusted for by appropriate calibration of the sensor output. The external location may protect the capacitor plates 61, 62 from possible damage caused by repeated insertion of the article 30 into the article interface 56, so any reduced sensitivity may be tolerable for this reason as least.

Also, the FIG. 4 example has capacitor plates 61, 62 of different size and area from one another. The first capacitor plate 61, located behind the upper wall of the article interface 56 and therefore above the article 30, has a first area Ac1. The second capacitor plate 62, located behind the lower wall of the article interface 56 and therefore under the article 30, has a second area Ac2 which is smaller than the first area Ac1. Hence, the capacitance measurement volume 63 extending between the perimeters of the capacitor plates 61, 62 has a tapered shape with sides which diverge along a direction from the bottom to the top of the area. An effect of this in the example as depicted is that the storage area 3 is located wholly within the capacitance measurement volume 63, but the article 30 is larger than the capacitance measurement volume 63 in a least one dimension, so that its end portions lie outside the capacitance measurement volume 63. The configuration of the FIG. 4 example is intended merely as a simple illustration of an arrangement in which the capacitor plates 61, 62 have different areas Ac1, Ac2. Other arrangements using this principle may be used instead, and configured as appropriate for relative shapes and positions of the article interface 56, the article 30 and the storage area 3 in order to conveniently embody a capacitance measurement volume which completely encompasses the storage area 3. For example, the upper, first, capacitor plate 61 may have the smaller area. One or more edges of the capacitor plates 61, 62 may be aligned in the vertical direction (as depicted) so that the capacitance measurement volume 63 has one or more non-diverging sides.

The various alternative features shown in the examples of FIGS. 3 and 4 and other examples described below may be employed in combinations other than those illustrated. Other modifications are also possible. For example, the first and second capacitor plates may be arranged at either side of the article interface with respect to the vertical orientation of the refilling dock, rather than the above and below positions shown in FIGS. 3 and 4. FIGS. 3 and 4 show the article held in the article interface in a generally horizontal orientation, where this can be defined with reference to a longitudinal axis of the article that extends along the article's longest dimension. In FIG. 3 this corresponds to a direction parallel to the dot-dash line representing the midway plane of the capacitance measurement volume. The article interface can therefore be configured to receive the article such that its longitudinal axis is horizontal (when the refilling dock is in its proper orientation for use), or near-horizontal, for example within 20 degrees of horizontal. A horizontal arrangement may facilitate insertion of the article into the article interface by the user, for example; it can be inserted along the longitudinal axis direction through an aperture or opening in the side of the refilling dock. A horizontal arrangement also allows the overall height of the dock to be reduced. The dock may be configured such that other orientations of the article interface and article are more suitable however, and non-horizontal arrangements are not excluded.

FIG. 5 shows a schematic and simplified end view of an example article interface in accordance with the disclosure, depicted from the open, insertion end of the article interface. An article 30 is received in the cavity of the article interface 56. The article 30 has a tapering mouthpiece end 35 as in the FIG. 3 example, with a mouthpiece outlet 36 for generated aerosol to exit for user consumption. The first and second capacitor plates 61, 62 are located above and below the article interface 56 as before, to define a capacitance measurement volume that corresponds to the cavity of the article interface 63, thereby encompassing both the storage area of the article (not shown) and the article 30. In this example the article 30 has a flattened geometry such that in the plane orthogonal to its longitudinal axis (which lies into the plane of the page in the depicted orientation) the article has a width dimension and a thickness dimension both orthogonal to the longitudinal axis, with the thickness t of the article 30 being less than (for example half or less than half) the width w. The article interface 56 and the capacitive sensor are configured such that when the article 30 is received in the article interface 56 the thickness of the article lies along the direction extending between the capacitor plates 61, 62, being the vertical direction in this example. In this way, the largest cross section of the article, and hence therefore also the largest cross section of the storage area (in some article designs at least), namely the cross-section parallel to the longitudinal and width directions and orthogonal to the thickness direction, is substantially parallel to the capacitor plates 61, 62. This configuration can increase the sensitivity of the capacitive sensor to changes in the fluid amount in the storage area compared to a geometry in which the capacitive sensor is aligned along the width direction. This thickness geometry can be similarly arranged along a direction perpendicular to the depicted orientation, with the thickness t of the article 30 lying horizontally and the capacitor plates at the sides of the article interface.

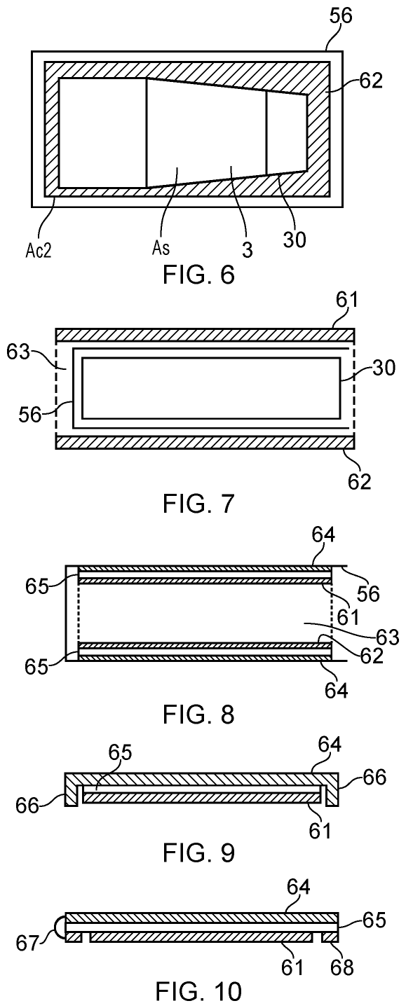

FIG. 6 shows a schematic simplified plan view of an example article interface similar to that of FIG. 3, as seen from the midway plane of the capacitance measurement volume, looking towards one of the capacitor plates. The article interface 56 has a generally rectangular shape (this is not limiting) and the capacitor plate 62 is secured to the inner wall of the article interface 56, occupying a slightly smaller area. The article 30 is received in the article interface 56, and in this example has a size and shape that places the article 30 wholly within the capacitance measurement volume extending from the perimeter of the capacitor plate 62. Hence, the storage are 3 of the article 30 is also located wholly within the capacitance measurement volume.

Placement of the capacitor plates inside the article interface as in the examples of FIGS. 3, 5 and 6 limits the maximum size of the capacitor plates to not bigger than the wall of the article interface housing with which each capacitor plate is associated. It is possible to enlarge the capacitor plates using a configuration in which the plates are placed outside the article interface.

FIG. 7 shows a highly schematic and simplified representation of an article interface according to a further example, in which the capacitor plates are located outside the article interface. As before, other components of the dock are omitted for simplicity. This is similar to the FIG. 4 example, but whereas in FIG. 4 the capacitor plates are smaller than the corresponding walls of the article interface, in this example the plates are larger. The article interface 56 again is configured as a cavity in which an article 30 is received through an opening in the side of the interface (either longitudinally, or sideways along the width or thickness direction of the article). The capacitor plates 61, 62 are disposed behind the walls of the article interface housing on opposite sides (above and below) of the article interface as before. In this example, however, the plates 61, 62 are sized so as to be bigger than the wall with which they are associated (along one or both dimensions in the plane of the plates), thereby having an area which is larger than the area of the corresponding walls. In this way, the entirety of the article interface is located inside the capacitance measurement volume 63 extending between the perimeters of the capacitor plates 61, 62 and indicated by the dotted lines, rather than the whole of the article or just the whole of the storage area (not shown) as in earlier examples. Such a configuration ensures that the storage area (which will likely extend to the boundary of the article along at least one dimension) is positioned inside the capacitance measurement volume regardless of any misalignment of the article within the article interface that may arise from user error, for example.

Enlargement of the capacitance measurement volume has other benefits. As is well-understood, edge effects at the perimeter of capacitor plates allow the capacitance sensing field to extend extraneously beyond the edges of the capacitance measurement volume defined above, (namely the region extending between the plates from perimeter to perimeter), with field lines reaching both around the sides of the plates and behind the plates for a considerable distance. These extraneous portions of the field can be sensitive to external interference. A capacitor configured with its capacitor plates significantly larger than item whose capacitance is required to be measured allows the item under measurement to be distanced from the field edges, so that measurements of capacitance variations in the item are less disrupted by external factors.

Protection from external interference can also be provided or enhanced by the use of electrical shielding around the capacitor plates. Shielding can improve electrical performance of the capacitive sensor, by confining and directing the capacitance field and thereby protecting the sensor from stray electrical fields and parasitic capacitance (such as from human touch near the sensor) that may interfere with the capacitance measurements and lead to inaccurate determinations of fluid level or amount by the controller. Shielding can be achieved by use of a more complex structure for the capacitor plates, in particular the provision of a conductive layer at the rear of each capacitor plate, and separated from the plate by an insulating layer. The conductive or shielding layer is electrically driven at the same voltage as is used for the capacitive sensor so that there is no potential difference between the shield and the capacitor plate.

FIG. 8 shows a schematic and simplified representation of an example article interface having a capacitive sensor configured with shielding. Electrical connections are not shown for simplicity. In this example, the article interface 56 has a capacitive sensor associated with it to define a capacitance measurement volume 63 within the article interface 56, the sensor comprising a first capacitor plate 61 at an upper wall of the article interface 56 and a second capacitor plate 62 at a lower wall of the article interface 56. The plates 61, 62 are shown as being located inside the article interface 56 but may alternatively be placed outside the article interface as in the FIGS. 4 and 7 examples. The capacitor plates 61, 62 are each provided with one or more insulating layers 65 immediately behind the plates, formed from a non-conductive material. A shielding layer 64 of a metallic/conductive material is provided behind the insulating layer 65, so that each capacitor plate 61, 62 is electrically isolated from its shielding layer 64 by the insulating layer 65. The effect of the shielding layers is to confine the capacitive sensing field of the capacitive sensor. The capacitance field lines can no longer extend behind the capacitor plates and are restricted also at the sides of the sensor, so that the capacitance field occupies a more similar space with the capacitance measurement volume, extending less far beyond it. In this way, capacitance measurements more accurately indicate the capacitance of the storage area and the article (or part of the article) only, being less subject to external interference effects.

FIG. 9 shows a schematic representation of a capacitor plate for use in a capacitive sensor provided with electrical (or “active”) shielding according to a further example. The plate 61 is provided with an insulating layer 65 as before, and a shielding layer 64 behind the insulating layer 65 to provide electrical isolation of plate, again as before. In this example, however, the shielding is extended into the plane of the capacitor plate 61. The shielding layer 64 has an extending rim, flange or side portions 66 which extend out of the plane of the shielding layer towards the capacitor plate 61 so as to surround the edges of the insulating layer 65 and the capacitor plate 61. A gap is provided between the rim 66 and the edges of the capacitor plate 61 in order to maintain the electrical isolation. Extending the shielding layer around the perimeter of the capacitor plate 61 in this way acts to further confine the capacitance field so that it more closely corresponds only to the capacitance measurement volume extending between the plate perimeters. Disruption from external interference and stray/parasitic capacitance is thereby reduced further and measurement accuracy improved.

FIG. 10 shows a schematic representation of a capacitor plate for use in a capacitive sensor provided with electrical shielding according to another example. As in the FIG. 9 example, the shielding is configured to extend around the perimeter of the capacitor plate. However, in this example, the shielding layer 64 comprises a planar (or other shape corresponding to the form of the capacitor plate 61) layer behind the insulating layer 65, and a shielding frame 68 located in the plane of the capacitor plate 61. The shielding frame 68 comprises a planar (or other corresponding shape) portion of the shielding material with a central aperture of the same or similar shape as the capacitor plate 61 but of larger area than the capacitor plate 61. The shielding frame 68 is positioned so that the capacitor plate lies within the aperture and spaced apart from the shielding frame all around its perimeter by a gap in order to achieve electrical isolation. An electrical coupling 67, such as by soldering or a wire) is provided between the shielding layer 64 and the shielding frame 68 so as to provide an electrically unified structure behind and around the perimeter of the capacitor plate 61, thereby providing a similar extensive shielding effect to the shielding layer of the FIG. 9 example in order to confine the capacitance field to the required capacitance measurement volume. The FIG. 10 configuration may be preferred as simpler to fabricate, since it can be formed from two sheet portions of the shielding material, avoiding the need to shape the shielding material into the rim of the FIG. 9 example.

It is also possible to provide one or more shielding layers at one or more sides of the capacitance sensing volume, being the sides where no capacitor plate is located.

The capacitor plates may be sized and shaped according to preference in order to provide a capacitance measurement volume large enough to accommodate and encompass the storage area of the article received in the article interface. The relative sizes have been discussed above in terms of the cross-sectional area of the capacitance measurement volume in a plane midway between the two capacitor plates as compared to the cross-sectional area of the received article in this same plane. As a minimum, the cross-sectional area of the capacitance measurement volume is 100% of the cross-sectional area of the storage area, in other words the areas are equal. Preferably, however, the cross-sectional area of the capacitance measurement volume is larger, for example in the range of 100% to 125% of the cross-sectional area of the storage volume. Still larger relative areas may give improved measurement accuracy, so that, for example, the cross-sectional area of the capacitance measurement volume may be in the range of 100% to 150% or 100% to 200% of the cross-sectional area of the storage volume. Considering the areas in terms of absolute values, the cross-sectional area of the capacitance measurement volume may be selected to as to be larger than the cross-sectional area of the storage area by extending beyond the cross-sectional area of the storage volume by a minimum dimension at all points around the entire perimeter of the cross-sectional area of the capacitance measurement volume. The minimum dimension may usefully be small, for example around 1 mm, but larger excesses may be used. Hence, the capacitance measurement volume cross-sectional area may be larger than the storage area cross-sectional area by at least 1 mm around its whole perimeter. In other examples, it may be larger by at least 2 mm, at least 3 mm or at least 5 mm. The size of the capacitance measurement volume depends on the size of the capacitor plates, which will be governed by the space available to accommodate the plates within the refilling dock, and possibly also within the article interface. Accordingly, other relative sizes may be used. In some cases, where space may be at a premium, it may be considered satisfactory for the capacitance measurement volume to accommodate most but not all of the storage area, so that the capacitance measurement volume may have a cross-sectional area which is in the range of 90% to 100% of the cross-sectional area of the storage area.

The volume of the storage area in an article may, for example, be between 1-2 ml (1000-2000 mm³). Assuming a minimum dimension for the article storage area of about 2 mm, in order to avoid capillary effects disrupting fluid flow within the storage area, and noting that this minimum dimension may lie in the relevant cross-sectional area or be orthogonal to it, the above maximum storage area volume gives a cross-sectional area of the storage area that may practically lie in the range of about 20-1000 mm². The cross-sectional area of the capacitance measurement volume may therefore in some examples also lie in the range of 20-1000 mm², while being also the same as or larger than the cross-sectional area of the storage area. Typically the article itself will have a external larger volume than the storage area in order to accommodate other parts and components in addition to the storage area. Purely by way of example, an article might have external dimensions of length and width (not considering the smallest dimension which we may designate as thickness) of 50 mm and 20 mm, or 35 mm and 15 mm. For these examples, in configurations where the capacitor plates are sized to encompass the whole of the article within the capacitance measurement volume, and the article is received horizontally in the article interface, and the capacitance measurement volume cross-section is larger than the storage area cross-section by about 1 mm all round, the capacitor plates may have areas of 52 mm by 22 mm, or 37 mm by 17 mm. Hence, we can define an example range for capacitor plate area of 37-52 mm by 17-22 mm, or 629 mm²-1144 mm², or more generally in the range of about 600 mm²-1200 mm², or more widely in the range of 400 mm²-2000 mm². Larger sizes may be more relevant for capacitive sensors in a reservoir interface, since a typical reservoir has a larger storage area than a typical article, and might have a size in the range of 600 mm²-2000 mm², for example, while smaller size plates may be more relevant in the context of an article interface, and might have a size in the range of 400 mm²-1200 mm², for example. These values are purely illustrative however, representing some practical examples only, and are not to be considered as limiting features.

In addition to size, one may consider the shapes of the cross-sectional areas. Conveniently, the cross-sectional area of the capacitance measurement volume may be the same shape or a similar shape as the cross-sectional area of the storage area, in order not to “waste” any of the capacitance measurement volume if the article is received with the storage area centrally aligned within the capacitance measurement volume. However, the individual shapes of the two areas need not be limited in this way and may be different, chosen with reference to other factors such as the configuration of the article, the article interface and the refilling dock.

The capacitive sensor may be configured in any of the usual ways which will be apparent to the skilled person, the only requirement being that the capacitor plates are suitably sized to define a capacitance measurement volume which is at least as large as the volume of the storage area of the article so that the storage area lies completely inside the capacitance measurement volume. For example, the sensor may be configured such that one of the capacitor plates is a “live” sensor plate or sensing plate to which an electrical voltage is applied and the other capacitor plate is a ground plate or receiving plate connected to electrical earth. In some examples, the sensing plate may be configured to be larger than the receiving plate, so that, with reference to FIG. 4, the first capacitor plate 61 is configured as the sensing plate and the second capacitor plate 62 is configured as the receiving plate. The plates may be formed from any conductive material, such as metallic foil or mesh, or a generally thin metallic plate.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A refilling device for filling an article from a reservoir, comprising:
an interface, the interface being an article interface for receiving an article of an aerosol provision system, the article having a storage area for fluid, or a reservoir interface for receiving a reservoir for filling an article of an aerosol provision system, the reservoir having a storage area for fluid; and
a capacitive sensor configured to measure a capacitance of the storage area when the article or reservoir is received in the interface;
wherein the capacitive sensor comprises a first capacitor plate and a second capacitor plate arranged at opposite sides of the interface to form a capacitance measurement volume in which the storage area of an article or reservoir is located when the article or reservoir is received in the interface, the capacitance measurement volume being between the first and second capacitor plates and extending from a perimeter of the first capacitor plate to a perimeter of the second capacitor plate, the capacitance measurement volume having a size such that the storage area of the article or reservoir received in the interface is located wholly within the capacitance measurement volume.

2. A refilling device according to claim 1, wherein an area of the first capacitor plate is substantially equal to an area of the second capacitor plate.

3. A refilling device according to claim 1, wherein an area of the first capacitor plate is different from an area of the second capacitor plate.

4. A refilling device according to claim 1, wherein the interface is an article interface, and one of the first capacitor plate and the second capacitor plate comprises one or more apertures through which a fluid delivery nozzle and/or an air venting nozzle can engage with the article to enable a filling action to deliver fluid into the storage area of the article.

5. A refilling device according to claim 1, wherein a cross-sectional area of the capacitance measurement volume in a plane midway between the first capacitor plate and the second capacitor plate is equal to or larger than a cross-sectional area of the storage area in the plane when the article or reservoir is received in the interface.

6. A refilling device according to claim 5, wherein the cross-sectional area of the capacitance measurement volume is the range of 100% to 200% of the cross-sectional area of the storage area.

7. A refilling device according to claim 5, wherein the cross-sectional area of the capacitance measurement volume is in the range of 100% to 125% of the cross-sectional area of the storage area.

8. A refilling device according to claim 5, wherein the cross-sectional area of the capacitance measurement volume exceeds the cross-sectional area of the storage area by at least one millimeter around a whole perimeter of the cross-sectional area of the capacitance measurement volume.

9. A refilling device according to claim 5, wherein the cross-sectional area of the capacitance measurement volume is the same shape as the cross-sectional area of the storage area.

10. A refilling device according to claim 1, wherein the interface is an article interface, and the article interface is configured to receive the article in a generally horizontal orientation such that a longitudinal axis of the article is horizontal or within 20 degrees of horizontal when the article is inserted in the article interface.

11. A refilling device according to claim 1, wherein the interface is an article interface, and the article interface is configured such that a thickness of the article orthogonal to a longitudinal axis of the article is located along a direction extending between the first and second capacitor plates.

12. A refilling device according to claim 1, wherein the first capacitor plate comprises a sensor plate and the second capacitor plate comprises a ground plate.

13. A refilling device according to claim 1, wherein the first and second capacitor plates each have a shielding layer external to the capacitance measurement volume and separated from the capacitor plate by an insulating layer.

14. A refilling device according to claim 13, wherein the shielding layer extends around the perimeter of the capacitor plate.

15. A refilling device according to claim 1, wherein the size of the capacitance measurement volume is such that the article or reservoir is located wholly within the capacitance measurement volume when received in the interface.

16. A refilling device according to claim 1, wherein the first capacitor plate and the second capacitor plate are located inside the interface.

17. A refilling device according to claim 1, wherein the first capacitor plate and the second capacitor plate are located outside the interface.

18. A refilling device according to claim 17, wherein the interface is located wholly within the capacitance measurement volume.

19. A refilling device according to claim 1, wherein the interface is an article interface, and the refilling device further comprising a controller configured to obtain capacitance measurements using the capacitive sensor, deduce an amount of fluid in the storage area of an article received in the article interface from one or more of the capacitance measurements, and control a filling action for filling the storage area from the reservoir based on the deduced amount of fluid.

20. A refilling system comprising:
a refilling device according to claim 1, wherein the interface is an article interface; and
an article of an aerosol provision system, the article having a storage area for fluid which is located wholly within the capacitance measurement volume when the article is received in the article interface.

21. A refilling system comprising:
a refilling device according to claim 1, wherein the interface is a reservoir interface; and
a reservoir for filling an article of an aerosol provision system, the reservoir having a storage area for fluid which is located wholly within the capacitance measurement volume when the reservoir is received in the reservoir interface.

22. A refilling device for filling an article from a reservoir, comprising:
an interface, the interface being an article interface for receiving an article of an aerosol provision system, the article having a storage area for fluid, or a reservoir interface for receiving a reservoir for filling an article of an aerosol provision system, the reservoir having a storage area for fluid; and
a capacitive sensor configured to measure a capacitance of the storage area when the article or reservoir is received in the interface;
wherein the capacitive sensor comprises a first capacitor plate and a second capacitor plate arranged at opposite sides of the interface to form a capacitance measurement volume in which the storage area of an article or reservoir is located when the article or reservoir is received in the article interface, the first capacitor plate having a first area and the second capacitor plate having a second area, the first area and the second area each being the range of 400 mm²-2000 mm².
